(19) United States
(12) Patent Application Publication
(10) Pub. No.: US 2015/0261399 A1
(43) Pub. Date: Sep. 17, 2015

(54) METHOD AND SYSTEM FOR PREDICTING AND AUTOMATING USER INTERACTION WITH COMPUTER PROGRAM USER INTERFACE

(71) Applicant: Yury Puzis, Stony Brook, NY (US)

(72) Inventor: Yury Puzis, Stony Brook, NY (US)

(21) Appl. No.: 14/215,962

(22) Filed: Mar. 17, 2014

(51) Int. Cl. G06F 3/0484; G06N 7/00; G06N 5/04

(52) U.S. Cl. CPC G06F 3/0484; G06N 5/04; G06N 7/005

(57) ABSTRACT

The invention is directed to predicting and automating user interaction with computer program user interfaces. Specifically, the invention comprises Sequence Alignment Table(s) that stores the history of user actions aligned with the recent user actions; predictive model to infer a list of suggested actions that are deemed most relevant for the user; the Automation User Interface for suggesting the predicted actions to the user; and Action Automator that facilitates execution of the predicted actions in the Computer Program User Interface. In this way, the invention helps users quickly go through sequences of actions to accomplish tasks.

### CROSS REFERENCE TO RELATED APPLICATION

This application claims the benefit of U.S. Provisional Application No. 61/791,115 filed on Mar. 15, 2013.

### FIELD OF THE INVENTION

The invention relates generally to the field of Information Technology (IT), and, more specifically, to systems and computer implemented methods for predicting and automating user interaction with computer program user interfaces.

### BACKGROUND OF THE INVENTION

With the proliferation of computer devices, people are now using a variety of Computer Program User Interfaces (CPUI). Accomplishing tasks with these CPUI (e.g., buying a product online, filling out a form, processing emails, etc.) requires performing a set of actions such as clicking links, buttons, doing gestures, entering information, speaking commands, etc. Unfortunately, finding the right actions to perform to advance in any given task requires understanding of the CPUI and/or remembering the actions that have to be performed. Current approaches enable automation of these actions by recording them in a macro and then replaying the macro as needed. However, macros have to be explicitly recorded; macros do not give the user the flexibility of diverging from the explicitly recorded sequences of actions; and macros do not give the user a choice of actions that can be taken.

### SUMMARY OF THE INVENTION

In general, embodiments of the invention provide approaches for predicting and automating user actions necessary for interaction with Computer Program User Interfaces (CPUI). Embodiments of the invention can predict future user actions for interaction with CPUI based on prior actions, suggest predicted actions to the user, and, if needed, execute actions on behalf of the user. As such, the invention allows users to interact with the CPUI quickly and with little effort.

One aspect of the present invention includes a computer implemented method for predicting and automating user interaction with CPUI, comprising the computer implemented steps of: updating Sequence Alignment Table(s) with user actions, inferring eligible future actions using the Action Predictor, suggesting the most probable actions to the user through the Automation User interface, and executing these actions in the CPUI with Action Automator on behalf of the user.

Another aspect of the present invention provides a system for predicting and automating user interaction with CPUI, comprising: a memory medium comprising instructions; a bus coupled to the memory medium; and a processor coupled to the bus that when executing the instructions causes the system to: update Sequence Alignment Table(s) with user actions, infer eligible future actions using the Action Predictor, suggest the most probable actions to the user through the Automation User interface, and execute these actions in the CPUI with Action Automator on behalf of the user.

Another aspect of the present invention provides a computer-readable storage medium storing computer instructions, which when executed, enables a computer system to predict and automate user interaction with CPUI, the computer instructions comprising: updating Sequence Alignment Table(s) with user actions, inferring eligible future actions using the Action Predictor, suggesting the most probable actions to the user through the Automation User interface, and executing these actions in the CPUI with Action Automator on behalf of the user.

Another aspect of the present invention provides a computer implemented method for predicting and automating user interaction with CPUI, comprising a computer infrastructure being operable to: update Sequence Alignment Table(s) with user actions, infer eligible future actions using the Action Predictor, suggest the most probable actions to the user through the Automation User interface, and execute these actions in the CPUI with Action Automator on behalf of the user.

### BRIEF DESCRIPTION OF THE DRAWINGS

FIG. 1 shows a pictorial representation of a network of data processing systems in which aspects of the illustrative embodiments may be implemented;

FIG. 2 shows a schematic of an exemplary computing environment in which elements of the present invention may operate;

FIG. 3 shows an embodiment of the invention operating in the environment shown in FIG. 1 and illustrates an exemplary architecture of an invention for predicting and automating user actions;

FIG. 4 shows an example of sequence alignment.

FIG. 5 shows a flow diagram of an approach for predicting and automating user actions according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements, which are referred to from the description of the invention.

### DETAILED DESCRIPTION OF THE INVENTION

Exemplary embodiments now will be described more fully herein with reference to the accompanying drawings, in which exemplary embodiments are shown. Embodiments of the invention combine a Sequence Alignment Table(s), Predictive Model, Automation User Interface, and Action Automator for executing user interaction with Computer Program User Interfaces (CPUI) on behalf of the user. Specifically, the invention comprises Sequence Alignment Table(s) that stores the history of user actions aligned with the recent user actions; predictive model to infer a list of suggested actions that are deemed most relevant for the user; the Automation User Interface for suggesting the predicted actions to the user; and Action Automator that facilitates the execution of the predicted actions in the CPUI on behalf of the user. In this way, the invention helps users quickly go through sequences of actions to accomplish tasks.

This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus appearances of the phrases “in one embodiment,” “in an embodiment,” “in embodiments” and similar language throughout this specification may, but do not necessarily, all refer to the same embodiment.

To better understand the embodiments of the invention, the present description will operate in the following terms. We will refer to any embodiment of the invention as Automation Assistant.

Computer Program User Interface (CPUI) is the user interface of any computer program, including but not limited to text editor, a web browser, a screen-reader, etc. The user interacts with the computer program through the user interface. It will be appreciated that the definition of the user interface is not limited by any particular implementation of the user interface.

The user interacts with the CPUI by performing Actions, including but not limited to: clicking links, buttons, doing gestures, entering information, speaking commands, etc. The Automation Assistant automates actions by executing actions in the CPUI on behalf of the user programmatically.

We define history as a sequence of actions that appear in the order in which they happened. An example of history is: <set “First Name” textbox to “John”, set the “Last Name” textbox to “Doe”, click the “Submit” button>.

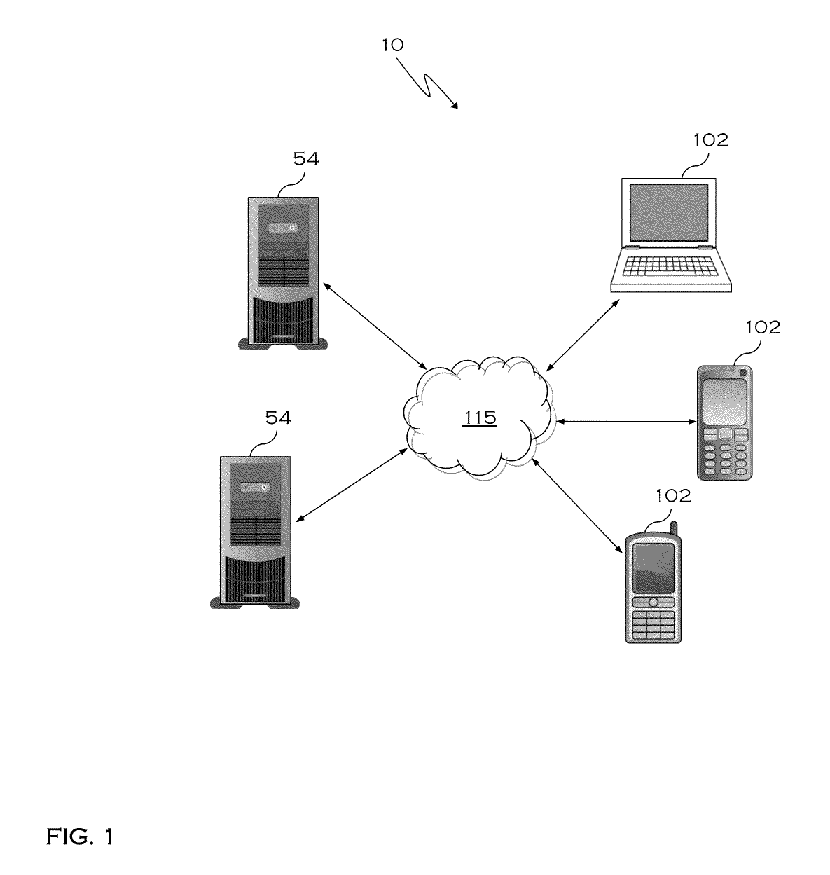

With reference now to the figures, FIG. 1 shows a pictorial representation of a network of data processing system 10 in which aspects of the illustrative embodiments may be implemented. Network data processing system 10 is a network of computers (e.g., mobile devices 102 and servers 54) in which embodiments may be implemented. Network data processing system 10 contains network 115, which is the medium used to provide communications links between various mobile devices 102, servers 54, and other computers connected together within network data processing system 10. For instance, the devices can use network 115 to synchronize playlist data. Network 115 may include connections, such as wire, wireless communication links, fiber optic cables, etc. It should be noted that exemplary embodiments of the invention are described in the context of a mobile computing device 102 (e.g., mobile telephone, laptop computer, tablet computer, e-reader, etc.). However, it will be appreciated that the invention is not limited by this description, and may encompass any number of computing infrastructures, architectures, and devices.

In the example depicted in FIG. 1, servers 54 and a set of mobile devices 102 connect to network 115. In the depicted example, servers 54 provide data, such as boot files, operating system images, and applications to mobile devices 102. Mobile devices 102 are clients to servers 54 in this example. Network data processing system 10 may include other servers, clients, and devices not shown.

In the exemplary embodiment, network data processing system 10 is the Internet with network 115 representing a worldwide collection of networks and gateways that use the Transmission Control Protocol/Internet Protocol (TCP/IP) suite of protocols to communicate with one another. At the heart of the Internet is a system of high-speed data communication lines between major nodes or host computers, consisting of thousands of commercial, governmental, educational, and other computer systems that route data and messages. It is understood that network data processing system 10 also may be implemented as a number of different types of networks, such as for example, an intranet, a local area network (LAN), or a wide area network (WAN). Network data processing system 10 represents one environment in which one or more mobile devices 102 operate, as will be described in further detail below. It will be appreciated that FIG. 1 is intended as an example, and not as an architectural limitation for different embodiments.

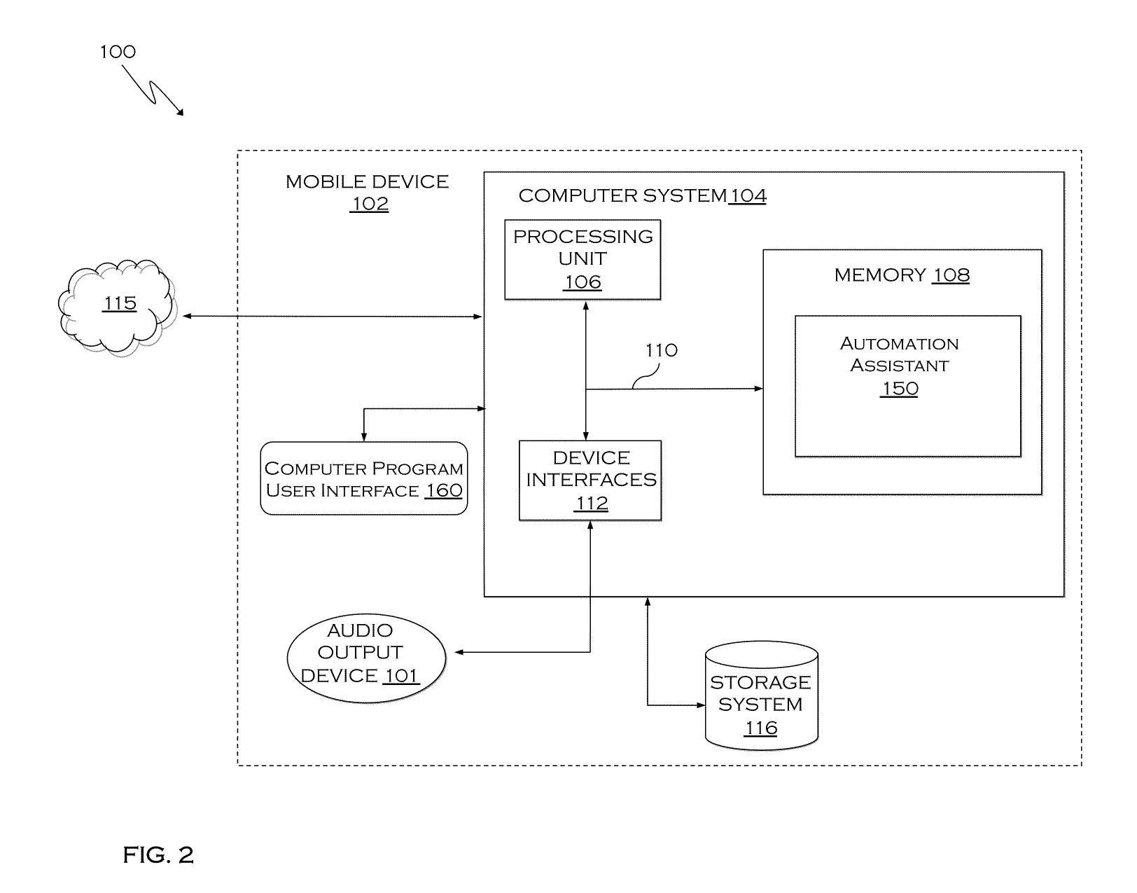

Turning now to FIG. 2, a computerized implementation 100 of the present invention will be described in greater detail. As depicted, computerized implementation 100 includes computer system 104 deployed within a mobile device 102 (e.g., computer infrastructure). This is intended to demonstrate, among other things, that the present invention could be implemented within network environment 115 (e.g., the Internet, a wide area network (WAN), a local area network (LAN), a virtual private network (VPN), etc.), or on a stand-alone computer system. Still yet, the computer infrastructure of mobile device 102 is intended to demonstrate that some or all of the components of computerized implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for combining Sequence Alignment Table(s), Predictive Model, Automation User Interface, and Action Automator for automating user interaction with Computer Program User Interfaces (CPUI). It should be understood that any other computers implemented under the present invention may have different components/software, but will perform similar functions. As shown, computer system 104 includes a processing unit 106 capable of operating with the Automation Assistant 150 stored in a memory unit 108 to Sequence Alignment Table(s), Predictive Model, Automation User Interface, and Action Automator for automating user interaction with Computer Program User Interfaces (CPUI), as will be described in further detail below. Also shown are device interfaces 112 allowing the computer system to connect to other devices, e.g., audio output device 101. Also shown is a bus 110 connecting various components of computer system 104.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 can collect and route data from the internet 115 to Automation Assistant 150. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating Automation Assistant 150, which is stored in memory 108 and/or storage system 116. While executing computer program code, processing unit 106 can read and/or write data to/from memory 108 and storage system 116. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that enable a user to interact with computer system 104 (e.g., keyboard, display, camera, touchpad, microphone, pointing device, speakers, etc.). A Computer Program User Interface 160 enable the user to interact with any computer program running in the Computer System 104.

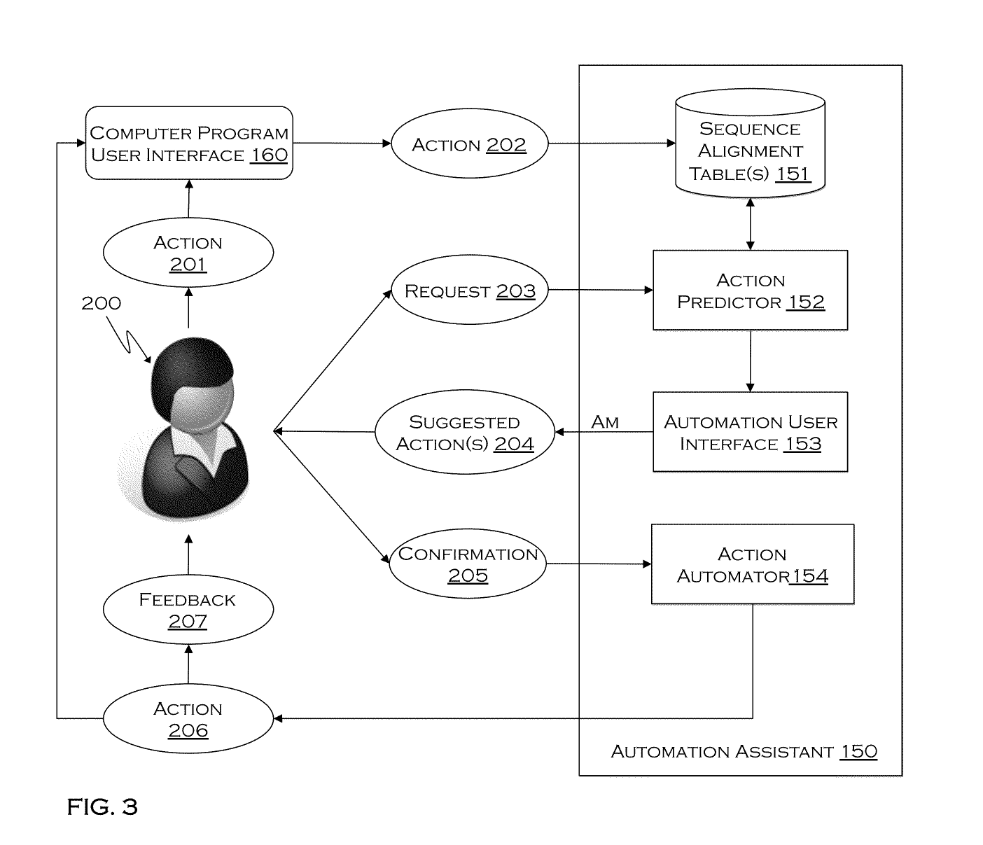

Turning now to FIG. 3, the structure and operation of the Automation Assistant 150 according to embodiments of the invention will be described in greater detail. The Automation Assistant 150 combines Sequence Alignment Table(s) 151, Action Predictor 152, Automation User Interface 153, and the Action Automator 154 for predicting and automating user actions in CPUI 160.

In one embodiment, Automation Assistant may be a thick-client wrapper (e.g., software code, program module(s), application program(s), etc.) running natively on mobile device 102. Depending on the platform/device, Automation Assistant 150 could be developed in Java, JavaScript, C++, C# .NET, Visual Basic (VB).net, Objective C, or any other computer programming language to run on Windows® devices, Android™ devices (Visual Basic® and WINDOWS® are registered trademarks of Microsoft Corporation, Objective C is a registered trademark of Apple Computer, Inc., JavaScript® is a registered trademark of ORACLE AMERICA, INC., and Android™ is a registered trademark of the Google Corporation). It will be appreciated if the listed languages and devices were not limiting the implementation for embodiments of the invention.

Automation Assistant 150 is configured to receive any Action 202 from the CPUI 160 (after the User 200 performs an Action 201 to the CPUI 160) and record it in the Sequence Alignment Table(s) component 151. Automation Assistant 150 comprises one or more Sequence Alignment Tables 151, which can be constructed by any sequence alignment algorithm, such as Smith-Waterman.

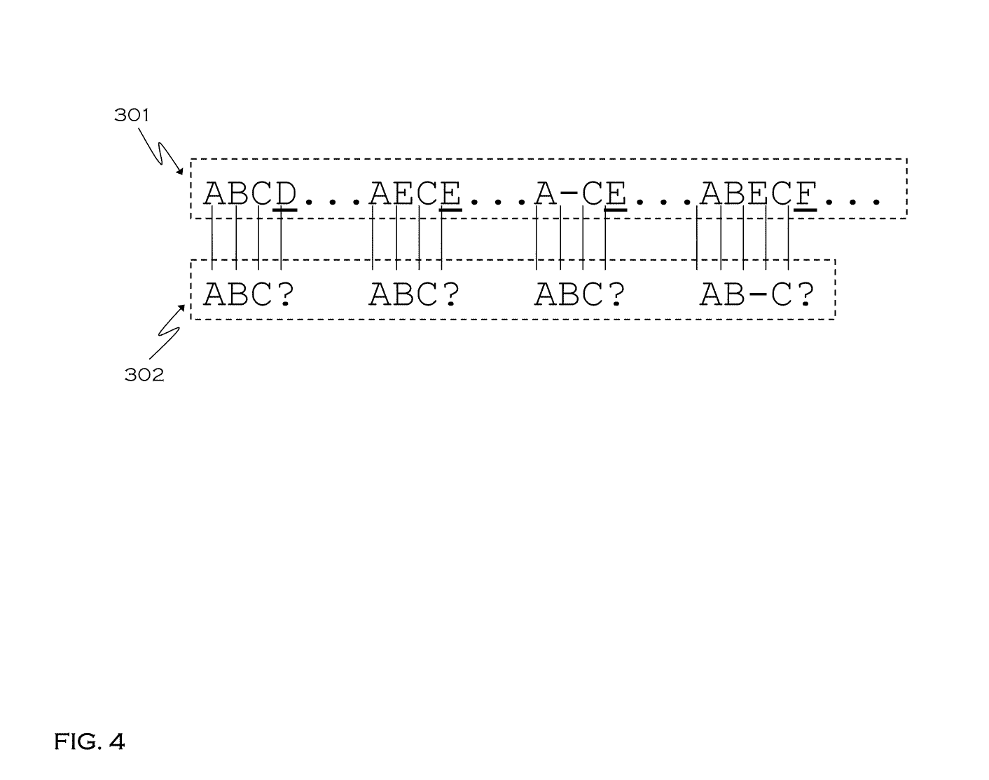

A Sequence Alignment Table 151 records the alignment between the history of user actions and recent user actions. FIG. 4 shows an illustration of a sequence alignment between user history 301 and recent user actions 302. Each alphabet letter represents an ordered list of one or more actions meant to be executed consecutively, and the same letter is used for an equivalent action list.

Some subsequence of the history may match (exactly or approximately) the recent user actions, then the action (or group of actions) immediately following the matched subsequence can be predicted as a possible action (or group of actions), and hence, it is a candidate for suggestion. In FIG. 4, recent user actions “ABC” 302 aligns with four subsequences of the history of user actions 301 “ABCD”, “AECE”, “ACE”, and “ABECF”. Then, the predicted possible user action (denoted by the “?” symbol) will be “D”, “E”, “E”, and “F” respectively.

Automation Assistant 150 operates with a Action Predictor 152, which uses the results of the sequence alignment from Sequence Alignment Table(s) 151 to choose the most likely eligible actions the user could perform. An action may be ineligible for various reasons, one such reason can be that action targets a user interface element (e.g., a button) does not exist in the CPUI 160.

Let the prediction list be defined as an ordered list of predicted actions. The Action Predictor 152 produces an ordered list of predicted actions. The list can be ordered using various methods such as the number of times the same action was performed by the user, the action with the highest alignment score in the Sequence Alignment Table(s) 151, the recency of the action in the table(s), and others. It will be appreciated that the invention is not limited by this description, because combination of different sequence alignment algorithms and the ordering approaches can produce different order prediction of predicted actions.

As further shown in FIG. 3, Automation Assistant 150 comprises an Automation User Interface 153 configured to make Suggested Action(s) 204 to the User 200 with the visual, audio, touch, temperature, movement, and other cues with the help of devices such as Audio Output Device 101 attached to Computer System 104. For example, audio feedback can focus user attention on the specific action, and may work as follows: if the suggestion is to enter value “John” to a textbox is labeled “First name”, then, the Automation User Interface may synthesize speech “Textbox ‘First name’ blank, Suggestion: John” when the user visits this textbox. Visual feedback may work by zooming and/or panning the screen of Device 102 to the textbox and/or identify the textbox visually, e.g., with a border. It will be appreciated that the invention is not limited by this description, as the Device 102 can enable a wide variety of cues that can be used to propose Suggested Action(s) 204 to User 200.

To synthesize speech that can be played by Audio Output Device 101, a speech synthesizer can be used. Speech Synthesis refers to the conversion of textual content into speech. A speech synthesizer is a system for speech synthesis that can be realized through software, hardware, or a combination of hardware/software. A typical speech synthesizer assigns phonetic transcriptions to each word, and divides and marks the text into prosodic units, like phrases, clauses, sentences, etc. Next, it converts the symbolic linguistic representation into sound, including pitch contour, phoneme durations, etc. It will be appreciated if speech synthesizer can use other processes to converting text to speech. It will be appreciated that speech synthesizer may be a sub component of the Device 102, server 54, or Automation Assistant 150.

Automation Assistant 150 further comprises Action Automator 154 configured to execute Action 206 on behalf of the User 200 in CPUI 160, upon an explicit or implicit confirmation 205 from the User, optionally providing the User with feedback using any of the available cues described above. Having reviewed the Suggested Action(s) 204 (e.g., visually, by touch, via audio, etc.), the User 200 can ignore them, perform the action independently, or let the Action Automator execute the suggested Action 206, by making a explicit Confirmation 205 using any input devices available with the device 102, including but not limited to: voice command, gesture, keyboard shortcut, mouse action. Implicit confirmation means that the user has agreed to execute actions without confirmation.

It can be appreciated that the approaches disclosed herein can be used within a computer system to provide interoperability between hardware functions and web documents, as shown in FIG. 2. In this case, Automation Assistant 150 can be provided, and one or more systems for performing the processes described in the invention can be obtained and deployed to mobile device 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

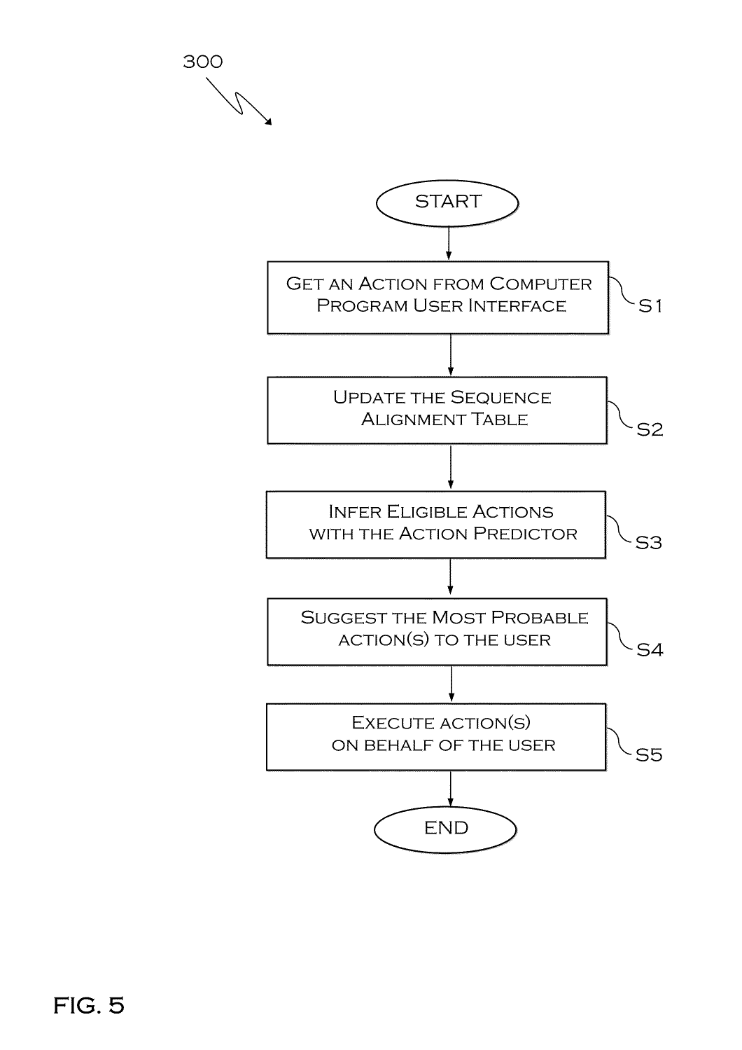

Computer system 104 carries out the methodologies disclosed herein, as shown in FIG. 5. We cross reference with FIG. 3. Shown is a computer implemented method 30 for predicting and automating user actions. At 51, the Automation Assistant receives action 202 from the CPUI environment 160. Next, at S2, the Sequence Alignment Table 151 is updated with the new action. Next, at S3, upon the Request 203 of the User 200 or automatically, eligible Actions are inferred by the Action Predictor 152. At S4, the most probable Action(s) are suggested to the user 204. Finally, at S5, if the User 200 Confirms 205 a suggested Action, the Action Automator 154 automates the corresponding Action 206 by executing them on behalf of the user in the CPUI 160.

The flowchart of FIG. 5 illustrates the architecture, functionality, and operation of possible implementations of systems, methods and computer program products according to various embodiments of the present invention. In this regard, each block in the flowcharts may represent a module, segment, or portion of code, which comprises one or more executable instructions for implementing the specified logical function(s). It should also be noted that, in some alternative implementations, the functions noted in the blocks might occur out of the order noted in the figures. For example, although S2 the Alignment Table is shown to be updated prior to S3 the inference of eligible Suggested Action(s) by the Action Predictor, it may also be possible to infer Suggested Action(s) S3 before S2 updating the Alignment Table. Furthermore, the process does not need to start at S1 and end at S5, e.g., S3 through S5 can be executed in one session if the user requests a suggestion, S1 through S2 can be executed in another session if user does not want suggestions, S5 can be skipped if the user does not like suggestions.

Additionally, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Many of the functional units described in this specification have been labeled as modules in order to more particularly emphasize their implementation independence. For example, a module may be implemented as a hardware circuit comprising custom VLSI (Very-Large-Scale Integration) circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

For example, an implementation of exemplary computer system 104 (FIG. 2) may be stored on or transmitted across some form of computer readable storage medium. Computer readable storage medium can be any available media that can be accessed by a computer. By way of example, and not limitation, computer readable storage medium may comprise “computer storage media” and “communications media.”

“Computer-readable storage medium” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

It is apparent that there has been provided an approach for providing interoperability between hardware functions and web documents. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A computer implemented method for combining sequence alignment table(s), Action Predictor, automation user interface, and action automator for predicting and automating user interaction with Computer Program User Interfaces, the method comprising the computer implemented steps of:
updating Sequence Alignment Table(s) with user actions;
inferring eligible future actions using the Action Predictor; and
suggesting the most probable actions to the user.

2. The computer implemented method according to claim 1, wherein updating Sequence Alignment Table(s) with user actions comprises the computer implemented steps for: appending a representation of each new user action to the sequence containing the history of user actions and the sequence containing recent user actions, and then running any sequence alignment algorithm to update the table(s).

3. The computer implemented method according to claim 1, wherein inferring eligible future actions using the Action Predictor comprises the computer implemented steps for performing at least one of the following: selecting the most probable future actions from the Sequence Alignment Table and ordering them.

4. The computer implemented method according to claim 1, wherein suggesting the most probable actions to the user comprises the computer implemented steps for performing at least one of the following:
enable the user to request Automation Assistant to make suggestions using any input device; or.
enable the Automation Assistant to make suggestions without an explicit request from the use.

5. The computer implemented method according to claim 1, wherein suggesting the most probable actions to the user comprises the computer implemented steps for: enabling the user to review the list of suggested actions presented by Automation Assistant via the Automation User Interface.

6. The computer implemented method according to claim 1, further comprising the computer implemented step of enabling:
an explicit confirmation, by the user, of the actions to be executed; or
an implicit confirmation to execute actions without asking the user.

7. The computer implemented method according to claim 1, further comprising the computer implemented step of: executing actions in Computer Program User Interfaces on behalf of the user.

8. A system for combining sequence alignment table(s), Action Predictor, automation user interface, and action automator for predicting and automating user interaction with Computer Program User Interfaces, the system comprising:
a memory medium comprising instructions;
a bus coupled to the memory medium; and
a processor coupled to the bus that when executing the instructions causes the system to:
updating Sequence Alignment Table(s) with user actions;
inferring eligible future actions using the Action Predictor; and
suggesting the most probable actions to the user.

9. The system according to claim 8, wherein updating Sequence Alignment Table(s) with user actions comprises instructions causing the system to enable:
appending a representation of each new user action to the sequence containing the history of user actions and the sequence containing recent user actions, and then running any sequence alignment algorithm to update the table(s).

10. The system according to claim 8, wherein inferring eligible future actions using the Action Predictor comprises instructions causing the system to perform at least one of the following: selecting the most probable future actions from the Sequence Alignment Table and ordering them.

11. The system according to claim 8, wherein suggesting the most probable actions to the user comprises instructions causing the system to enable at least one of the following:
enable the user to request Automation Assistant to make suggestions using any input device; or.
enable the Automation Assistant to make suggestions without an explicit request from the use.

12. The system according to claim 8, wherein suggesting the most probable actions to the user comprises instructions causing the system to enable: the user to review the list of suggested actions presented by Automation Assistant via the Automation User Interface.

13. The system according to claim 8, further comprising instructions causing the system to enable:
an explicit confirmation, by the user, of the actions to be executed; or
an implicit confirmation to execute actions without asking the user.

14. The system according to claim 8, further comprising instructions causing the system to: execute actions in Computer Program User Interfaces on behalf of the user.

15. A computer-readable storage medium storing computer instructions, which when executed, enables a computer system to combine sequence alignment table(s), Action Predictor, automation user interface, and action automator for predicting and automating user interaction with Computer Program User Interfaces, the computer instructions comprising:
updating Sequence Alignment Table(s) with user actions;
inferring eligible future actions using the Action Predictor; and
suggesting the most probable actions to the user.

16. The computer-readable storage device according to claim 15 wherein updating Sequence Alignment Table(s) with user actions comprises computer instructions for: appending a representation of each new user action to the sequence containing the history of user actions and the sequence containing recent user actions, and then running any sequence alignment algorithm to update the table(s).

17. The computer-readable storage device according to claim 15 wherein inferring eligible future actions using the Action Predictor comprises computer instructions for performing at least one of the following: selecting the most probable future actions from the Sequence Alignment Table and ordering them.

18. The computer-readable storage device according to claim 15 wherein suggesting the most probable actions to the user comprises computer instructions for:
enable the user to request Automation Assistant to make suggestions using any input device; or.
enable the Automation Assistant to make suggestions without an explicit request from the use.

19. The computer-readable storage device according to claim 15 further comprising computer instructions for performing at least one of the following: enabling the user to review the suggested actions presented by the Automation User Interface and explicitly or implicitly confirm the actions to be executed.

20. The computer-readable storage device according to claim 15 further comprising computer instructions for: executing actions in Computer Program User Interfaces on behalf of the user.
